(19) United States
(12) Patent Application Publication
(10) Pub. No.: US 2007/0028519 A1
(43) Pub. Date: Feb. 8, 2007

(54) Cover sleeve for a container

(76) Inventors: Amy R. Seibel, Mequon, WI (US); Patricia L. Herzog-Mesrobian, Mequon, WI (US)

Correspondence Address: Absolute Technology Law Group, LLC, Fourth Floor, 207 East Michigan Street, Milwaukee, WI, 53202, US

(21) Appl. No.: 11/546,461

(22) Filed: Oct. 11, 2006

Related U.S. Application Data
(63) Continuation-in-part of application No. 10/649,490, filed on Aug. 27, 2003, now abandoned.

(51) Int. Cl. A01G 9/02

(52) U.S. Cl. 47/72

(57) ABSTRACT

A cover sleeve for a container comprised of: a top portion being generally circular and having an inner edge and an outer edge, the inner edge forming a top aperture; a side portion shaped similarly to a sidewall of the container and engaging the outer edge of the top portion, and having a first and second vertical edge; a fastening mechanism temporarily securing the first vertical edge to the second vertical edge, allowing the cover sleeve to be removably secured over the container; and at least one securing member on the cover sleeve to temporarily secure it to the container. The cover sleeve can further include a bottom portion, a mounting mechanism, and/or at least one decorative indicia.

### CROSS-REFERENCE TO RELATED APPLICATION

This invention is a continuation-in-part of and claims priority to United States non-provisional patent application Ser. No. 10/649,490, filed on 27 Aug. 2003, incorporated herein in its entirety.

### FIELD OF INVENTION

This invention relates generally to the field of a cover for a container, and in particular to the field of a removable cover sleeve for use with a flowerpot or another container.

### BRIEF DESCRIPTION OF THE DRAWINGS

FIG. 1 shows a top perspective view of one embodiment of a cover sleeve positioned on a plant container.

FIG. 2 shows a cross-sectional view of the embodiment of the cover sleeve positioned on the plant container shown in FIG. 1 taken along line 2-2 of FIG. 1.

FIG. 3a shows a top perspective view of one embodiment of a mounting mechanism that can be attached to the cover sleeve to allow the plant container to be suspended or mounted.

FIG. 3b shows an alternate use of the mounting mechanism shown in FIG. 3a that can be used to secure the cover sleeve and the container which it covers to the ground or other surface.

FIG. 3c shows an alternate use of the mounting mechanism shown in FIG. 3a that can be used to secure one cover sleeve to another cover sleeve.

FIG. 4 shows a top perspective view of one alternate embodiment of a mounting mechanism.

FIG. 5a shows a side view of one embodiment of a fastening mechanism for temporarily securing the two ends of the cover sleeve together.

FIG. 5b shows a side view of one alternate embodiment of a fastening mechanism.

FIG. 6 shows a side view of one alternate embodiment of a cover sleeve further including decorative indicia.

FIGS. 7a and 7b are side views of alternate embodiments of a cover sleeve in which the cover sleeve also covers a container base.

### DETAILED DESCRIPTION OF EMBODIMENTS OF THE INVENTION

For the purpose of promoting an understanding of the present invention, references are made in the text hereof to embodiments of a cover sleeve for a plant container, some of which are depicted in the drawings. It should nevertheless be understood that no limitations on the scope of the invention are thereby intended. For example, the cover sleeve can be used to cover a container for other plants or for another container such as a wastebasket or pencil holder. Moreover, one of ordinary skill in the art will readily appreciate that modifications such as those involving the number of components, materials or size of the components, the inclusion of additional elements, and different or alternate shapes of the container and cover sleeve for same, do not depart from the spirit and scope of the present invention. Some of these possible modifications are mentioned in the following description.

In addition, in the embodiments depicted herein, like reference numerals refer to identical structural elements in the various drawings. Therefore, specific details disclosed herein are not to be interpreted as limiting, but rather as a basis for the claims and as a representative basis for teaching one skilled in the art to employ the present invention in virtually any appropriately detailed apparatus, structure, or manner.

Moreover, the term “substantially” or “approximately” as used herein may be applied to modify any quantitative representation that could permissibly vary without resulting in a change in the basic function to which it is related. For example, one embodiment of a container and cover sleeve for same are generally frustaconical, with the bottom surface being of a smaller diameter than the diameter of the top surface. The shape of the container and cover sleeve for same might permissibly be such that the diameter of the bottom surface is the same as or greater than to the diameter of the top surface, that the sidewall of the container and the side surface of the cover sleeve be arcuately or irregularly shaped, or that the top and bottom layers of the container and the top and bottom surfaces of the cover sleeve need not be circular and still be within the scope of the invention if the functionality is not materially altered.

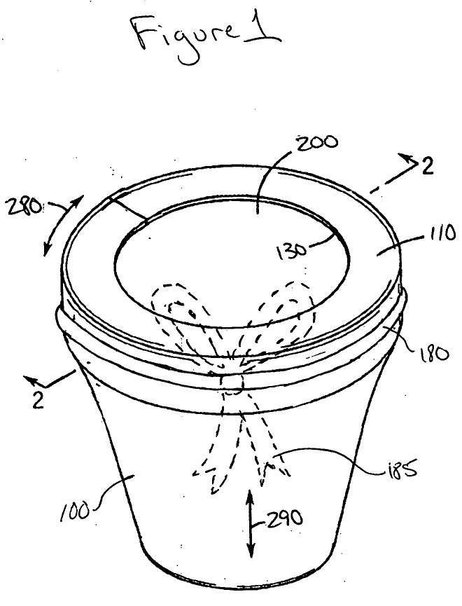

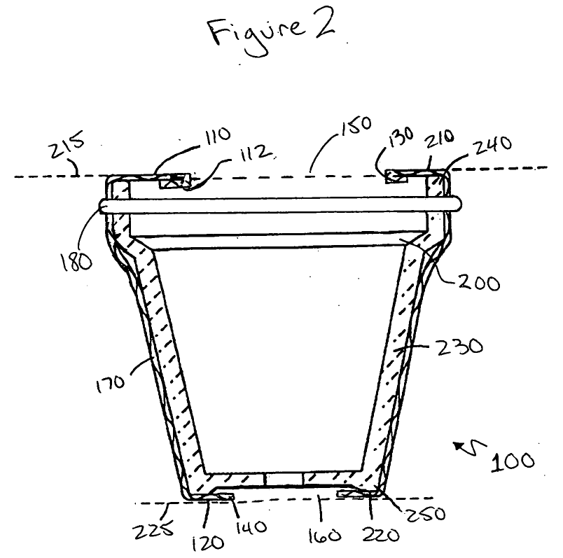

FIG. 1 shows a top perspective view of one embodiment of cover sleeve 100 positioned on plant container 200, and FIG. 2 shows a cross-sectional view of the embodiment of cover sleeve 100 positioned on the embodiment of plant container 200 shown in FIG. 1 taken along line 2-2 of FIG. 1. As stated supra, the use of cover sleeve 100 on plant container 200 is intended to be a non-limiting example; cover sleeve 100 can be used in conjunction with any shape, style, or size container. Referring to FIGS. 1 and 2 collectively, plant container 200, for example a flower pot, is comprised of top surface 210 in first horizontal plane 215 and bottom surface 220 lying in second horizontal plane 225, sidewall 230 extending between top surface 210 and bottom surface 220, upper corner 240 at the interface between top surface 210 and sidewall 230, and lower corner 250 at the interface between bottom surface 220 and sidewall 230. Cover sleeve 100 extends along sidewall 230 and around upper corner 240 and lower corner 250. Cover sleeve 100 has a flat horizontal annular upper portion 110 lying along first horizontal plane 215, a flat horizontal annular lower portion 120 lying in second horizontal plane 225, and side member 170 generally perpendicular to upper portion 110 and lower portion 120. Upper portion 110 of cover sleeve 100 extends horizontally inwardly along first horizontal plane 215 to upper inner lip 130 coplanar with upper corner 240 along first horizontal plane 215. Lower portion 120 of cover sleeve 100 extends horizontally inwardly along second horizontal plane 225 to lower inner lip 140 coplanar with lower corner 250 along second horizontal plane 225. Upper portion 110 and lower portion 120 of cover sleeve 100 are substantially parallel. Upper inner lip 130 defines upper aperture 150, and lower inner lip 140 defines lower aperture 160 coaxially aligned with and of smaller diameter than upper aperture 150. Upper portion 110 of cover sleeve 100 terminates in first horizontal plane 215, and lower portion 120 of cover sleeve 100 terminates in second horizontal plane 225.

In an alternate embodiment of cover sleeve 100, cover sleeve is comprised of only flat horizontal annular upper portion 110, lying along first horizontal plane 215, and side member 170. That is, this alternate embodiment does not include the lower portion.

In the embodiment shown in FIGS. 1 and 2, cover sleeve 100 is composed of an air permeable elastic material. The air permeability provides breathability for healthier soil and plant life in plant container 200. Clay flower pots are air permeable and hence breathable. The noted elasticity provides a conformed fit of cover sleeve 100 around plant container 200 and facilitates stretchability, enabling cover sleeve 100 to more tightly conform to the shape of plant container 200. In the embodiment of cover sleeve 100 shown in FIGS. 1 and 2, cover sleeve is made of a polyester material. In alternate embodiments, cover sleeve 100 can be made of lycra, tight weave nylon lycra, patent leather, leather, synthetic leather, or combinations thereof.

In another embodiment of cover sleeve 100, cover sleeve 100 is made of a knitted material, further allowing for the breathability and stretchability of cover sleeve 100 around plant container 200. Cover sleeve 100 could alternately be made of any material known and used in the art that allows for the breathability and stretchability of cover sleeve 100. It should be understood, too, that cover sleeve 100 can be constructed using several pieces sewn or otherwise attached to one another, or cover sleeve 100 can be formed of a single piece, with or without a seam. In addition, for an embodiment of cover sleeve 100 constructed of multiple pieces, each piece can be of the same material or of alternate materials. Finally, in a further embodiment, cover sleeve 100 can be a multi-layer composite having a first layer comprising material stretchable along both hoop direction 280 and axial direction 290 and a second layer coated on the first layer. One such second layer is polyurethane and can provide a leather-look, a grained look, or a vinyl look. Cover sleeve 100 can also be a combination of stretch and non-stretch textural yarns for a three-dimensional look, e.g. multiple fibers knitted together to make a base fabric in a knitted process. Examples of materials that can be knitted to make cover sleeve 100 include polyester, lycra, tight weave nylon lycra, patent leather, leather, synthetic leather, yarn, and combinations thereof.

Plant container 200 has hoop direction 280 along the circumference of upper corner 240 and axial direction 290 along the height of plant container 200. The material from which cover sleeve 100 is made is stretchable along one or both of hoop direction 280 and/or axial direction 290. Depending upon applications, the material may be stretchable along only one of hoop direction 280 or axial direction 290 may be sufficient and may be desirable for cost savings.

In one embodiment, cover sleeve 100 includes folded-back portion 112 at upper inner lip 130 extending horizontally back along and engaging upper portion 110 and stitched (or otherwise connected by any means known in the art) thereto. In the embodiment shown in FIG. 2, folded-back portion 112 engages the underside of upper portion 110. However, it should be understood that in an alternate embodiment of cover sleeve 100, folded-back portion 112 can be stitched or otherwise connected to the top side of upper portion 110. Moreover, it should be understood that the same can be done with lower portion 120 of cover sleeve 100 (not shown). In yet another embodiment, folded back portion 112 can be rolled back to form an independent collar)

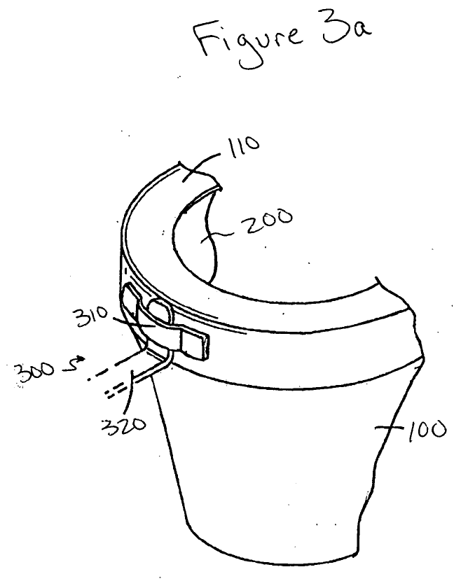

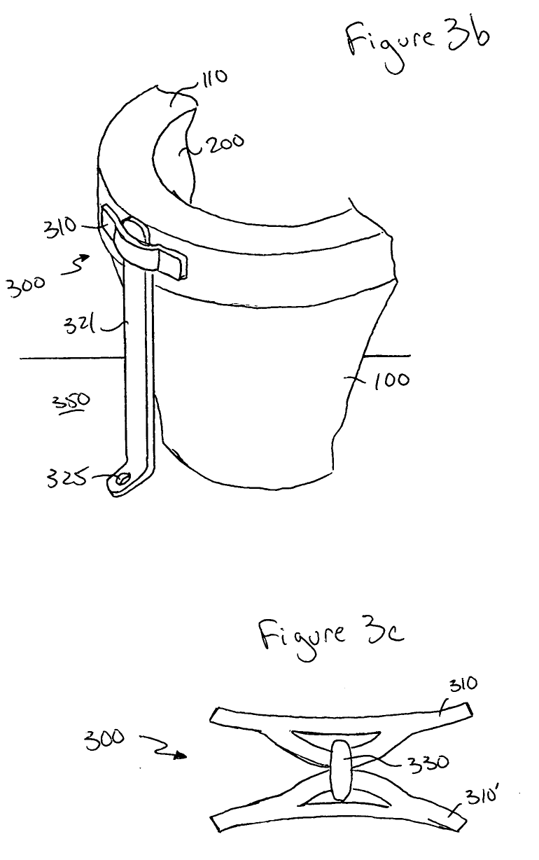

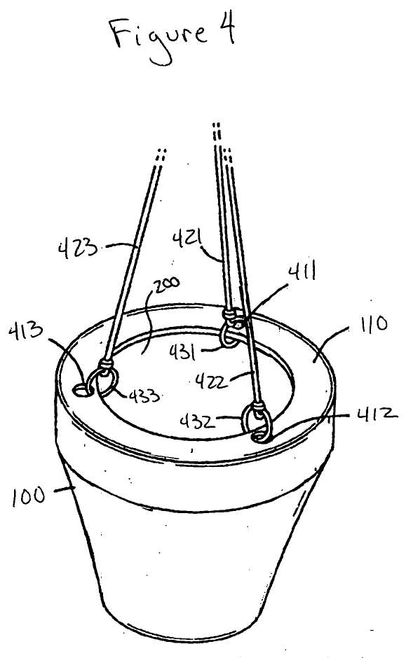

FIG. 3a shows a top perspective view of one embodiment of mounting mechanism 300 that can be attached to cover sleeve 100 to allow plant container 200 to be suspended. As used herein, “mounting mechanism” refers to any mechanism, one or more components, system, or means used to permanently or temporarily position cover sleeve 100 and container 200 to a railing, to a surface, in a suspended manner, or otherwise position cover sleeve 200 and container 100. In this embodiment, tab 310 is attached to cover sleeve 100 for receiving mounting arm 320 for suspending plant container 200 therefrom.

FIG. 3b shows an alternate use of mounting mechanism 300 shown in FIG. 3a. Mounting mechanism 300 is used to secure cover sleeve 100 and container 200 which it covers to ground surface 350 or other surface (e.g., a table or desk) using mounting arm 321 and tab 310. Mounting arm 321 is comprised of aperture 325, which allows mounting mechanism to be secured to ground surface 350 by a nail, screw, or other means commonly known and used in the art. This embodiment of mounting mechanism 300 or that shown in FIG. 3b can further be used to secure container 200 and cover sleeve 100 to a railing, a table, a desk, or any other surface.

FIG. 3c shows an alternate use of mounting mechanism 300 shown in FIG. 3a. This embodiment of mounting mechanism is used to secure one cover sleeve (not shown), having first tab 310 secured thereto, to another cover sleeve (not shown), having second tab 310′ secured thereto. Each tab 310, 310′ is secured to one another by tie 330. Tie can be metal, plastic, or any other material that allows each cover sleeve to be secured to another, either permanently or temporarily. This allows multiple cover sleeves and containers to be secured to one another to increase stability. Moreover, each container can include multiple tabs 310 secured thereto, allowing several containers to be secured to one another, further increasing stability.

FIG. 4 shows a top perspective view of one alternate embodiment of mounting mechanism 400, i.e., to suspend cover sleeve and container 200. In this embodiment, upper portion 110 of cover sleeve 100 has a plurality of apertures 411, 412, 413 therethrough at which stringers 421, 422, and 423 are respectively attached by respective rings 431, 432, and 433.

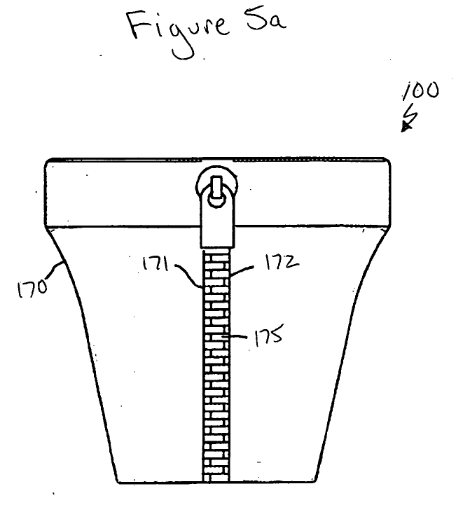

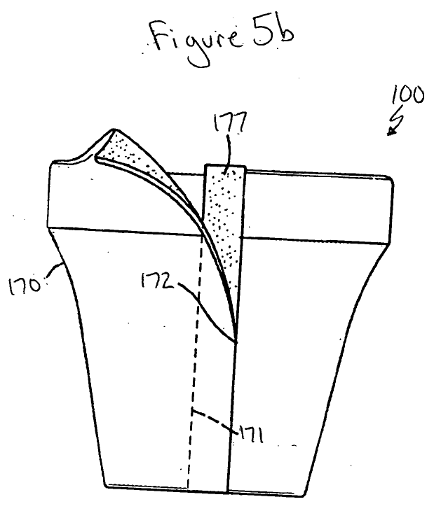

FIG. 5a shows a side view of one embodiment of a fastening mechanism for temporarily securing first vertical edge 171 of side member 170 of cover sleeve 100 to second vertical edge 172 of side member 170 of cover sleeve 100. In the embodiment shown, first vertical edge 171 and second vertical edge 172 are attached to each other by zipper 175. The use of zipper 175 allows cover sleeve 100 to be wrapped around the container (not visible) without having to slide the container into cover sleeve 100, or stated another way, without having to lift the container and slide cover sleeve 100 around the container. It also allows for the subsequent removal of cover sleeve 100, i.e., a temporary affixation of cover sleeve 100 to the container.

FIG. 5b shows a side view of one alternate embodiment of a fastening mechanism. In this embodiment, first vertical edge 171 of side member 170 of cover sleeve 100 is temporarily secured to second vertical edge 172 of side member 170 of cover sleeve 100 by hook and loop fastener 177, sometimes called Velcro™. Again, the use of hook and loop fastener 177 allows for the temporary affixation of cover sleeve 100 to the container without having to necessarily lift the container and slide cover sleeve 100 over the container. One of ordinary skill in the art will appreciate that any other fastening mechanisms known and used in the art could alternately be employed to temporarily affix first vertical edge 171 of side member 170 of cover sleeve 100 to second vertical edge 172 of side member 170 of cover sleeve 100, including but not limited to snaps, a gusset, a wrap and tie, ring closures, grommets and laces, hook and eyes, buttons, fabric adhesives, buckles, clasps, envelope closures, a halter top closure, and combinations thereof, allowing cover sleeve 100 to be removably secured over the container.

Referring again to FIGS. 1 and 2, also visible is one embodiment of securing member 180. Securing member 180 helps maintain the position of cover sleeve 100 over container 200. Securing member circumvents cover sleeve 100 and container 200 and exerts an inward pressure, creating an increase in pressure between side member 170 of cover sleeve 100 and sidewall 230 of plant container 200. In the embodiment shown, securing member 180 is made of an elastic material, specifically a rubber material. In alternate embodiments, securing member 180 can be made of any stretchable material that allows it to be stretched around the container and maintain a sufficient pressure against the container. Moreover, securing member can also be used to hold an inner or interior liner in the container in place when it wraps over the top and along the outside of the container, e.g., a liner for a wastebasket or a plastic liner. It should also be understood that in alternate embodiments, securing member 180 could be one or more twist ties, one or more draw strings, a crimping metal, one or more plastic bands with sizing holes, one or more leather or synthetic leather belts, a clamping chain, one or more tying cords, and combinations thereof. In addition, securing member could be colored to be the same color as cover sleeve 100 or an alternate color or colors to provide aesthetic effect. Securing member 180 can further include a fabric covering securing member for a more aesthetic look. Moreover, securing member can further comprise decorative member 185 to add to the aesthetic appearance. One example of decorative member 185 is, as shown, a bow.

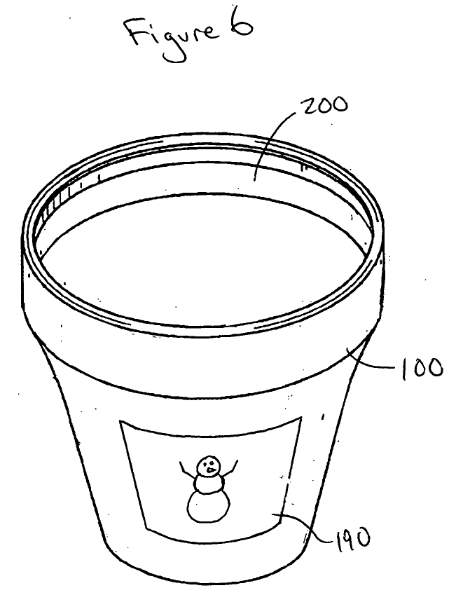

FIG. 6 shows a side view of one alternate embodiment of cover sleeve 100 including decorative indicia 190. In one embodiment, the inner layer (not shown) is a polyurethane coated fabric with a high gloss finish as well as a heavier weight vinyl allowing for better adhesive qualities. The outer layer of indicia 190 is comprised of a flexible and low weight static cling plastic material, i.e., a PVC film which clings to the smooth high gloss surface of the sleeve cover. The composition of the static cling should be of a low weight and thickness to provide the necessary pliability and adherence characteristics.

Also, because of the shape of the pot (includes an arc) the indicia has to be applied in the center front and can not be too long horizontally or it will fall off—unless it is wrapped all around and adhered to the ends of each other. The pressure sensitivity of the film makes it repositionable to take advantage of the best receptive surface. Indicia 190 can be applied to cover sleeve 100 either directly, through the application of a removable film, or by affixing a pocket to cover sleeve 100 into which indicia 190 can be placed. Such features can serve a variety of purposes and functions. One purpose is to allow for the decoration of cover sleeve 100 itself in the form of a graphic (as shown). Another purpose would be to add a text message to cover sleeve 100. The text message could be to convey a holiday greeting, e.g., Merry Christmas, Happy Valentine's Day, etc., or another message related to another special day such as a birthday, a wedding, an anniversary, Mother's Day, Father's Day, etc. A brand name, company name, corporate logo, advertising slogan, or other graphic could also be added to cover sleeve 100. Further, indicia 190 could convey a message to an individual, such as “I Love You,” “Renee,” “First Place,” etc. Indicia 195 could be used to advertise the selling of cover sleeve 100 itself. Moreover, indicia 195 could be used to convey a particular or special event such as a rock concert or family reunion. It is intended that the present invention encompass any form of indicia 195 that an owner might want attached to cover sleeve 100.

Moreover, a wide variety of decorative implements could also be added to cover sleeve 100. Examples include holograms, stickers, pictures, photographs, beads, dangling decoration, buttons, or any other decorative appliqué. The appliqués can include various shapes and sizes of fixed films, two-dimensional and three-dimensional objects. It is intended that the present invention contemplate craft kits which would be sold that include beads, stickers, or other decorative tools to enable an individual to decorate cover sleeve 100 in any manner described herein or any other manner an individual desires.

In one embodiment of cover sleeve 100, indicia 190 is directly applied to cover sleeve 100 using a silk screen process, hot press printing, or other means of applying one or more designs to the fabric known in the art during the manufacturing process. Indicia 190 could also be applied to cover sleeve 100 by the owner. In such an embodiment, a removable film is used that has decorations or other indicia on it. The film can be attached to cover sleeve 100 using static adhesion, glue, a pin, a button, a snap, a hook, a fastener, or any other mechanism or means known in the art. Such a design allows for changing the overall design of cover sleeve 100 depending on the season or event.

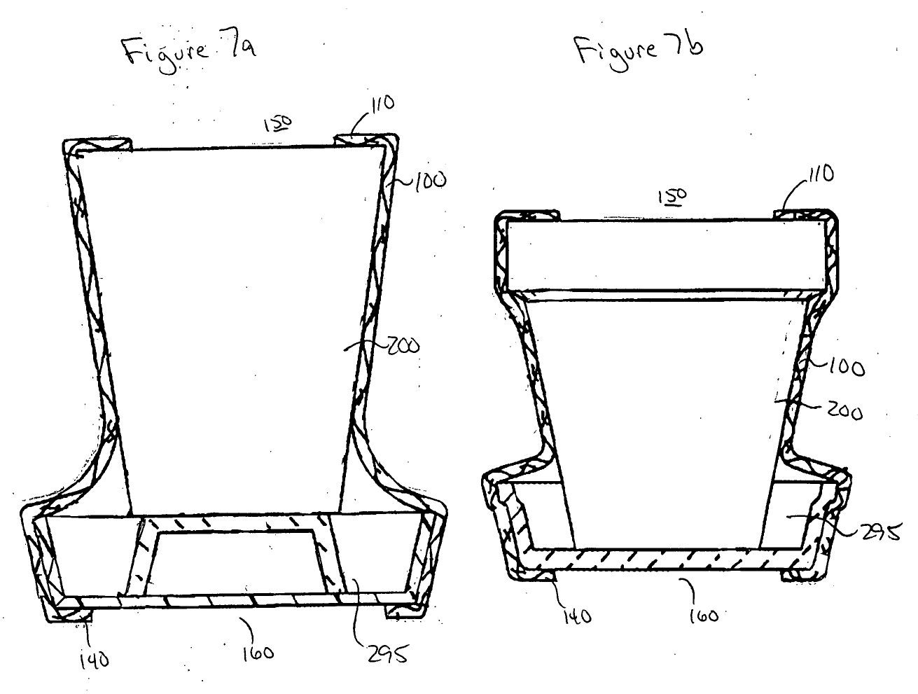

FIGS. 7a and 7b are side views of alternate embodiments of cover sleeve 100. In the embodiment of cover sleeve 100 shown in FIGS. 7a and 7b, upper portion 110, upper aperture 150, lower inner lip 140, and lower aperture 160 of cover sleeve 100 can all be seen, and container 200 further comprises container base 295. In the embodiments shown, cover sleeve 100 is formed to also cover container base 295, collectively referred to as container 200.

While the cover sleeve has been shown and described with respect to several embodiments in accordance with the present invention, it is to be understood that the same is not limited thereto, but is susceptible to numerous changes and modifications as known to a person skilled in the art, and it is intended that the present invention not be limited to the details shown and described herein, but rather cover all such changes and modifications obvious to one of ordinary skill in the art.

What is claimed is:

1. A cover sleeve for a container comprised of:
a top portion, said top portion being generally circular and having an inner edge and an outer edge, said inner edge forming a top aperture;
a side portion, said side portion shaped similarly to a sidewall of said container and engaging said outer edge of said top portion, and said side portion having a first vertical edge and a second vertical edge;
a fastening mechanism, said fastening mechanism temporarily securing said first vertical edge of said side portion to said second vertical edge of said side portion, allowing said cover sleeve to be removably secured over said container; and
at least one securing member positioned on said cover sleeve to temporarily secure said cover sleeve to said container.

2. The cover sleeve of claim 1, wherein said cover sleeve is further comprised of a bottom portion, said bottom portion being generally circular and having an outer edge, said outer edge having a diameter smaller than a diameter of said top portion.

3. The cover sleeve of claim 2, wherein said bottom portion is further comprised of an inner edge forming a bottom aperture.

4. The cover sleeve of claim 1, wherein said container is comprised of: a top surface in a first horizontal plane, a bottom surface lying in a second horizontal plane, said sidewall extending between said top surface and said bottom surface, an upper corner at an interface of said top surface and said sidewall, and a lower corner at an interface of said bottom surface and said sidewall, wherein said container has a hoop direction along a circumference or said top surface and an axial direction along a height between said top surface and said bottom surface, and wherein said cover sleeve is comprised of a material stretchable along at least one of said hoop direction and said axial direction.

5. The cover sleeve of claim 1, wherein said cover sleeve is made of a material selected from a group comprised of polyester, lycra, tight weave nylon lycra, patent leather, leather, synthetic leather, yarn, and combinations thereof.

6. The cover sleeve of claim 1, wherein said cover sleeve is comprised of a plurality of layers.

7. The cover sleeve of claim 1, wherein said cover sleeve is further comprised of a mounting mechanism.

8. The cover sleeve of claim 1, wherein said fastening mechanism is selected from a group comprised of a zipper, a hook and loop fastener, at least one snap, a gusset, a wrap and tie, at least one ring closure, at least one grommet and at least one lace, at least one hook and at least one eye, at least one button, at least one fabric adhesive, at least one buckle, at least one clasp, an envelope closure, a halter top closure, and combinations thereof, allowing said cover sleeve to be removably secured over said container.

9. The cover sleeve of claim 1, wherein said at least one securing member is selected from a group comprised of an elastic member, at least one twist tie, at least one draw string, a crimping metal, at least one plastic band with a plurality of sizing holes, at least one leather or synthetic leather belt, a clamping chain, at least one tying cord, and combinations thereof.

10. The cover sleeve of claim 1, wherein said securing member is further comprised of an aesthetic covering.

11. The cover sleeve of claim 1, wherein said cover sleeve further includes at least one decorative indicia disposed thereon.

12. The cover sleeve of claim 11, wherein said at least one decorative indicia is comprised of an inner layer and an outer layer, wherein said inner layer is a polyurethane coated fabric with a high gloss and said outer layer is comprised of a flexible and low weight static cling plastic material.

13. A cover sleeve for a container comprised of:
a top portion, said top portion being generally circular and having an inner edge and an outer edge, said inner edge forming a top aperture;
a bottom portion, said bottom portion being generally circular, having an outer edge and having a diameter smaller than a diameter of said top portion;
a side portion extending between said outer edge of said top portion and said outer edge of said bottom portion, said side portion having a generally cylindrical shape, a first vertical edge, and a second vertical edge;
a fastening mechanism, said fastening mechanism temporarily securing said first vertical edge of said side portion to said second vertical edge of said side portion and allowing said cover sleeve to be removably secured over said container; and
at least one securing member positioned on said cover sleeve to temporarily secure said cover sleeve to said container.

14. The cover sleeve of claim 13, wherein said bottom portion is further comprised of an inner edge forming a bottom aperture.

15. The cover sleeve of claim 13, wherein said cover sleeve is made of a material selected from a group comprised of polyester, lycra, tight weave nylon lycra, patent leather, leather, synthetic leather, yarn, and combinations thereof.

16. The cover sleeve of claim 13, wherein said cover sleeve is comprised of a plurality of layers.

17. The cover sleeve of claim 13, wherein said container is comprised of: a top surface in a first horizontal plane, a bottom surface lying in a second horizontal plane, said sidewall extending between said top surface and said bottom surface, an upper corner at an interface of said top surface and said sidewall, and a lower corner at an interface of said bottom surface and said sidewall, wherein said container has a hoop direction along a circumference or said top surface and an axial direction along a height between said top surface and said bottom surface, and wherein said cover sleeve is comprised of a material stretchable along at least one of said hoop direction and said axial direction.

18. The cover sleeve of claim 13, wherein said cover sleeve is further comprised of a mounting mechanism.

19. The cover sleeve of claim 13, wherein said fastening mechanism is selected from a group comprised of a zipper, a hook and loop fastener, at least one snap, a gusset, a wrap and tie, at least one ring closure, at least one grommet and at least one lace, at least one hook and at least one eye, at least one button, at least one fabric adhesive, at least one buckle, at least one clasp, an envelope closure, a halter top closure, and combinations thereof.

20. The cover sleeve of claim 13, wherein said at least one securing member is selected from a group comprised of an elastic member, at least one twist tie, at least one draw string, a crimping metal, at least one plastic band with a plurality of sizing holes, at least one leather or synthetic leather belt, a clamping chain, at least one tying cord, and combinations thereof.

21. The cover sleeve of claim 13, wherein said securing member is further comprised of an aesthetic covering.

22. The cover sleeve of claim 13, wherein said cover sleeve further includes at least one decorative indicia disposed thereon.

23. The cover sleeve of claim 22, wherein said at least one decorative indicia is comprised of an inner layer and an outer layer, wherein said inner layer is a polyurethane coated fabric with a high gloss and said outer layer is comprised of a flexible and low weight static cling plastic material.

24. A cover sleeve for a container comprised of:
a top portion, said top portion being generally circular and having an inner edge and an outer edge, said inner edge forming a top aperture;
a bottom portion, said bottom portion being generally circular, having an outer edge and having a diameter smaller than a diameter of said top portion;
a side portion extending between said outer edge of said top portion and said outer edge of said bottom portion, said side portion having a generally cylindrical shape, a first vertical edge, and a second vertical edge;
a fastening mechanism, said fastening mechanism temporarily securing said first vertical edge of said side portion to said second vertical edge of said side portion and allowing said cover sleeve to be removably secured over said container; and
at least one securing member positioned on said cover sleeve to temporarily secure said cover sleeve to said container;
wherein said is container comprised of:
a top surface in a first horizontal plane;
a bottom surface lying in a second horizontal plane;
a sidewall extending between said top surface and said bottom surface;
an upper corner at an interface of said top surface and said sidewall; and
a lower corner at an interface of said bottom surface and said sidewall, wherein said container has a hoop direction along a circumference or said top surface and an axial direction along a height between said top surface and said bottom surface; and
wherein said cover sleeve comprises material stretchable along at least one of said hoop direction and said axial direction.

25. The cover sleeve of claim 24, wherein said bottom portion is further comprised of an inner edge forming a bottom aperture.

26. The cover sleeve of claim 24, wherein said cover sleeve is made of a material selected from a group comprised of polyester, lycra, tight weave nylon lycra, patent leather, leather, synthetic leather, yarn, and combinations thereof.

27. The cover sleeve of claim 24, wherein said cover sleeve is comprised of a plurality of layers.

28. The cover sleeve of claim 24, wherein said cover sleeve is further comprised of a mounting mechanism.

29. The cover sleeve of claim 24, wherein said fastening mechanism is selected from a group comprised of a zipper, a hook and loop fastener, at least one snap, a gusset, a wrap and tie, at least one ring closure, at least one grommet and at least one lace, at least one hook and at least one eye, at least one button, at least one fabric adhesive, at least one buckle, at least one clasp, an envelope closure, a halter top closure, and combinations thereof allowing said cover sleeve to be removably secured over said container.

30. The cover sleeve of claim 24, wherein said at least one securing member is selected from a group comprised of an elastic member, at least one twist tie, at least one draw string, a crimping metal, at least one plastic band with a plurality of sizing holes, at least one leather or synthetic leather belt, a clamping chain, at least one tying cord, and combinations thereof.

31. The cover sleeve of claim 24, wherein said securing member is further comprised of an aesthetic covering.

32. The cover sleeve of claim 24, wherein said cover sleeve further includes at least one decorative indicia disposed thereon.

33. The cover sleeve of claim 32, wherein said at least one decorative indicia is comprised of an inner layer and an outer layer, wherein said inner layer is a polyurethane coated fabric with a high gloss and said outer layer is comprised of a flexible and low weight static cling plastic material.
